(19) United States
(12) Patent Application Publication
(10) Pub. No.: US 2026/0010659 A1
(43) Pub. Date: Jan. 8, 2026

(54) Device for Destroying the Functionality of Data Bearing Components of a Solid-State Data Bearing Device

(71) Applicant: Sepehr Rajaie, Reynoldsburg, OH (US)

(72) Inventor: Sepehr Rajaie, Reynoldsburg, OH (US)

(21) Appl. No.: 19/330,000

(22) Filed: Sep. 16, 2025

Related U.S. Application Data
(63) Continuation-in-part of application No. 17/139,881, filed on Dec. 31, 2020.

(51) Int. Cl. G06F 21/79

(52) U.S. Cl. CPC G06F 21/79

(57) ABSTRACT

The current invention is a device for Destroying the Functionality of Data Bearing Components of a Solid-State Data Bearing Device. This device provides destruction of data bearing components from solid-state data bearing devices by reducing the components to particle size of 2 mm or smaller and ensures accurate particle size by use of a screening system to render the data unusable using a simple one stage process. The device is portable and is intended to be used within the customer's secure confines of a data center or enterprise facility.

### CROSS-REFERENCES TO RELATED APPLICATIONS (IF ANY)

Continuation-in-part of U.S. application Ser. No. 17/139,881 filed on Dec. 21, 2020.

### BACKGROUND

### 1. Field of the Invention

The present invention relates to a Device for Destroying the Functionality of Data Bearing Components of a Solid-State Data Bearing Device destroying data bearing components of the solid-state data bearing devices

### 2. Description of Prior Art

The problem with the solid-state patents, machines and technology is that the current industry designs depend on powerful machines to shred, grind and reduce the fiberglass circuit boards to the 2 mm particle size. First, the current technology uses multiple stage mechanisms to reduce components. All these machines run on multiple (2 or 3) phase power to do the work, and those types of outlets are not present throughout a commercial building, where 120 single phase power is everywhere. The current machines weigh many hundred or even a thousand pounds and are not made to be lightweight and mobile. The wheels on the current type of machine are present but because of weight, size and power, the machines are not designed to be in office facilities. Then with these types of machines, the tooling is prone for wearing and have to be changed or calibrated daily, weekly or monthly. The current machines always have dust in the air and outside the collection system.

The current machines can weigh hundreds to thousands of pounds. While they may have wheels to move into a permanent position they are not truly mobile. They have to run on 2 or 3 phase power that is not readily available in all areas of a commercial facility. They must have their cutting tools changed daily, weekly, or monthly due to wear from shredding, cutting, and grinding. Their construction is not dust tight.

There is still room for improvement in the art.

### SUMMARY OF THE INVENTION

The present invention is a Device that provides destruction of data bearing components from solid-state data bearing devices by reducing the components to particle size of 2 mm or smaller and ensures accurate particle size by use of a screening system to render the data unusable using a simple one stage process. Since there are so few mechanical components in the design, a Device can last 100 times longer than a shredding machine with a fraction of the complexity to build. This Device is portable and is intended to be used within the customer's secure confines of a data center or enterprise facility. This Device includes a particle collection system and a filtration system to preserve air quality where it is located.

This Device uses a hammer principle rather than cutting, shredding, and grinding. The hammer is more efficient than cutting, shredding or grinding. This allows for a more efficient machine that requires less power and can run on single phase. 120 VAC, 20A. The more efficient device weighs less and is easily moved in a facility.

The device is a high impact chain mechanism It is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows a cross-cut front view of the current device.

FIG. 2 shows a cross-cut side view of the current device.

FIG. 3 shows a cross-cut back view of the current device.

FIG. 4 shows a diagram of some of the components of the invention.

FIG. 5 shows a cross-cut front view of the high impact chain mechanism apparatus.

FIG. 6 shows a cross-cut side view of the high impact chain mechanism apparatus.

### COMPONENTS

1. Outer Case 9.
2. A Drop-in drawer with safety guard 40.
3. A Single stage destructive apparatus 50 with a motor 55.
4. A Size filtering screen system 100.
5. A Particle Collection System 200 for containing particles 300 after destruction.
6. An Air filtration system 80.

### DESCRIPTION OF THE PREFERRED EMBODIMENT

There are a number of significant design features and improvements incorporated within the invention.

If the data bearing device that presently or at one time held data is at the end of life, then the organization will want to safely and securely destroy the data from data bearing components of solid-state data bearing devices. When the solid-state data bearing device has been determined as ready for decommissioning and is removed from the host server or array or other computer device, then it will be processed and designated for destruction. When a solid-state data bearing device is designated for destruction, the trained technician of the Device 1 will remove the circuit board from the solid-state data bearing device. If the circuit board has been removed from the solid-state data bearing device, the trained technician of the Device will insert the circuit board into the Device 1. If the circuit board has been inserted into the Device 1, then the Device 1 will reduce the data bearing components to a particle size of 2 mm or smaller. If the data bearing components have been reduced to a particle size of 2 mm or smaller, the remnants will move through the size filtering screen system which is set for 2 mm or smaller. If the particles from the data bearing components move through the size filtering screen system which is set for 2 mm or smaller, the particles meet the size designated in cybersecurity regulations for making data unusable. If the particles meet the size designated in cybersecurity regulations for making data unusable, then the solid-state components have been determined to be non-functional and the data unreadable. If the data is unreadable, then the particles are collected in the particle-lizer for disposal.

This Device 1 provides destruction of data bearing components from solid-state data bearing devices. It is different and better than existing machines since it is small, lightweight, has lifetime calibration, and runs on ordinary 120-volt, 50/60 Hz, single phase power. The machine does not show any wear after years of use. No cutting blades need to be changed, sharpened, or calibrated to achieve the 2 mm particle size. The hammer principle is more efficient than cutting, shredding, or grinding.

Solid-state data bearing devices 10 that eventually fail or are decommissioned are separated from the host server or array or other computer device and need to have the functionality of the solid-state data bearing components destroyed so that the data is no longer usable. The invention claimed here solves this problem.

When the failed or decommissioned solid-state data bearing device 10 is removed from the host server or array or other computer device and is designated for destruction of data, the circuit board of the solid-state device 10 will be removed from the solid-state device 10 and inserted into the Device 1.

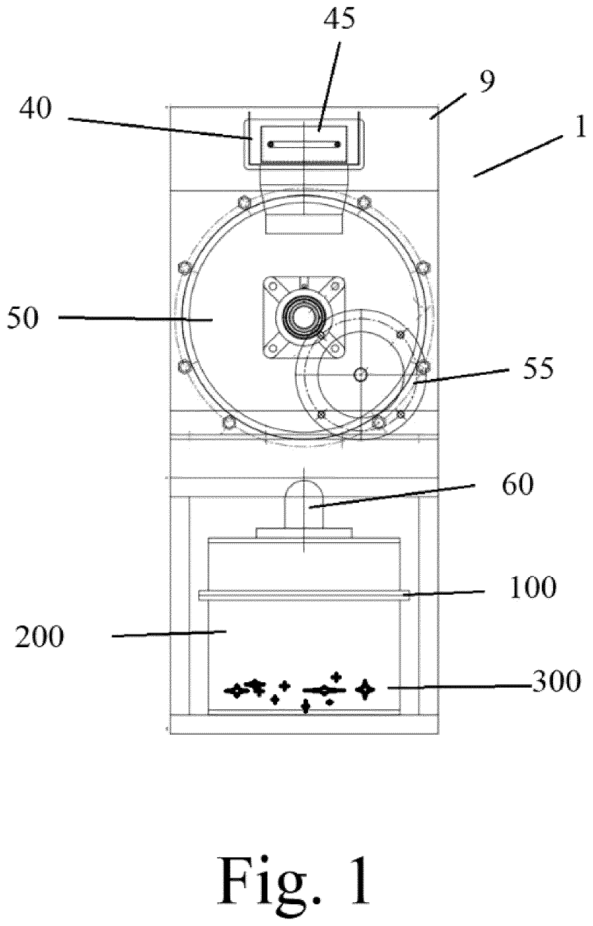

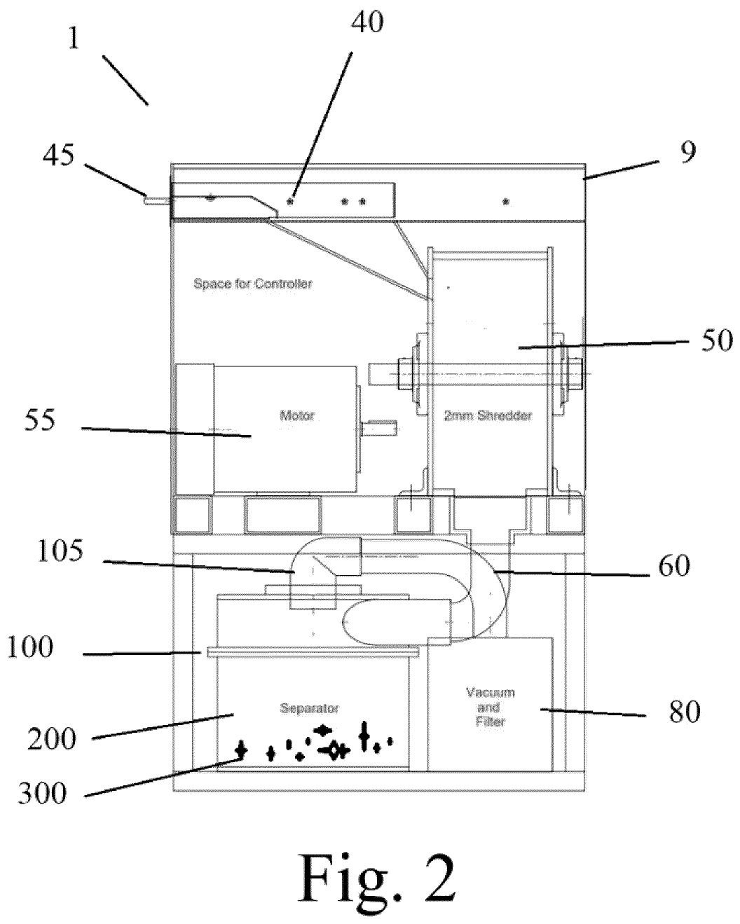

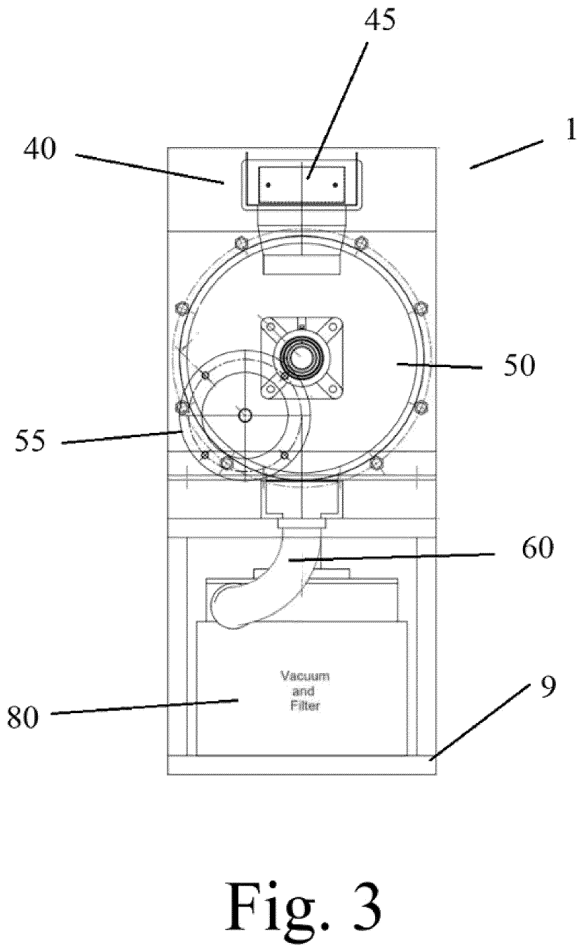

As shown in FIGS. 1 through 3, the current invention will separate the data bearing components from the circuit board and reduce them to a particle size of 2 mm or smaller in order to flow through a 2 mm screen 100, which per cybersecurity regulations, renders the data unusable. The device/particle-lizer 1 uses a new approach to solid state destruction that is more energy efficient and processes more solid-state components in less time with a single stage process. The particles 300 will be collected in a particle collection system 200 within the device 1. The waste particles that become airborne will be collected safely inside the device 1.

The device 1 has an outer case 9 in which all the components are positioned within. In the front is a Drop-in drawer with safety guard 40. The Solid-state data bearing devices 10 are placed in the drop-in drawer 40 and go to the Single stage destructive apparatus 50 which in the preferred embodiment uses a hammering process, such as a high impact chain mechanism, to destroy the Solid-state data bearing devices 10. In the preferred embodiment the single stage destructive apparatus 50 is driven by a motor 55. The motor 55 can be electrical and runs on standard 120-volt single phase power receptacle or a similar power means.

The hammering process reduces Solid-state data bearing devices 10 to particles 300. The particles 300 will flow through a particle tube 60 from the single stage destructive apparatus 50 to the particle collection system 200. The collection system 200 will have an adjustable size filtering screen system 100. The size filtering screen system 100 has a screen while allows particles 300 that are smaller than a desired size to be collected in the bottom holding area of the particle collection system 200. The screening filter in the filtering screen system 100 can be changed out for different desired sizes. In the preferred embodiment, a 2 mm screen filter is used.

At the top of the particle collection system 200 is an air filtration hose 65 that runs to an Air filtration system 80. The air filtration system 80 uses a negative air pressure such as a fan to pull the air and micro dust from the particle collection system 200 through a filter so the dust in captured and not released into the air outside of the outer case 9. This increases the safety factor and allows the device 1 to be used in any inside or outside location. The air filtration system 80 is connected to the collection system 200 by an air filtration tube 105.

The Device 1 provides destruction of data bearing components from solid-state data bearing devices 10 and ensures accurate particle size to render the data unusable using a single stage process. This Device 1 includes a filtration system 80 to preserve air quality where it is located. Also, this Device 1 can be produced in a variety of sizes to allow for efficient use and transportation to customers' secure locations.

The components can be configured to produce remnants of different particle sizes based on the screening of the particles 300.

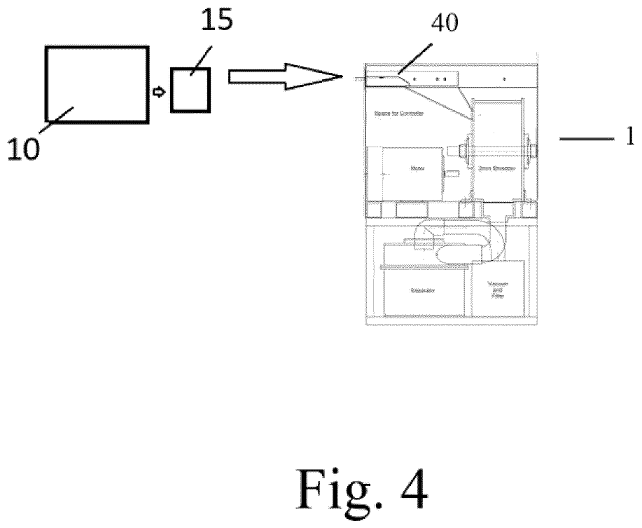

As shown in FIG. 4, a circuit board has been inserted into the Device 1, then the Device1 will reduce the data bearing components 15 to a particle size of 2 mm or smaller. If the data bearing components 15 have been reduced to a particle size of 2 mm or smaller, the remnants will move through the size filtering screen system 100 which is set for 2 mm or smaller. If the particles 300 from the data bearing components 15 move through the size filtering screen system 100 which is set for 2 mm or smaller, the particles 300 meet the size designated in cybersecurity regulations for making data unusable. If the particles 300 meet the size designated in cybersecurity regulations for making data unusable, then the solid-state components 15 have been determined to be non-functional and the data unreadable.

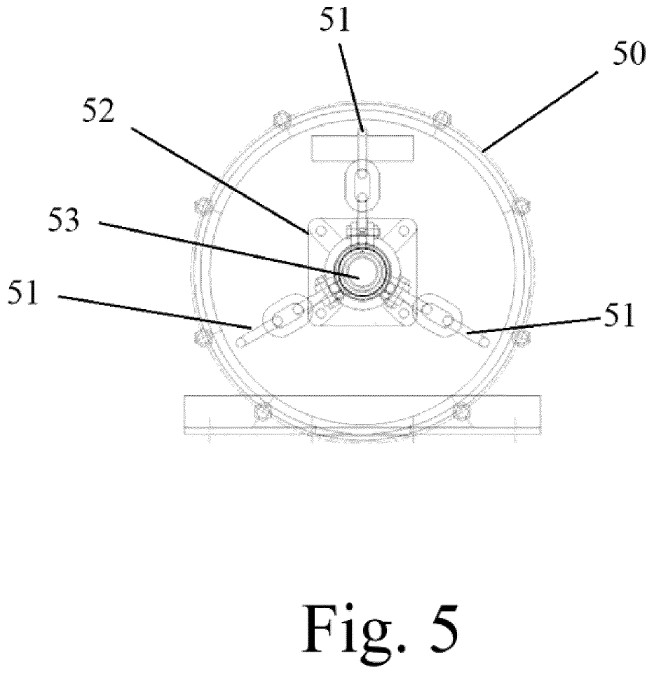

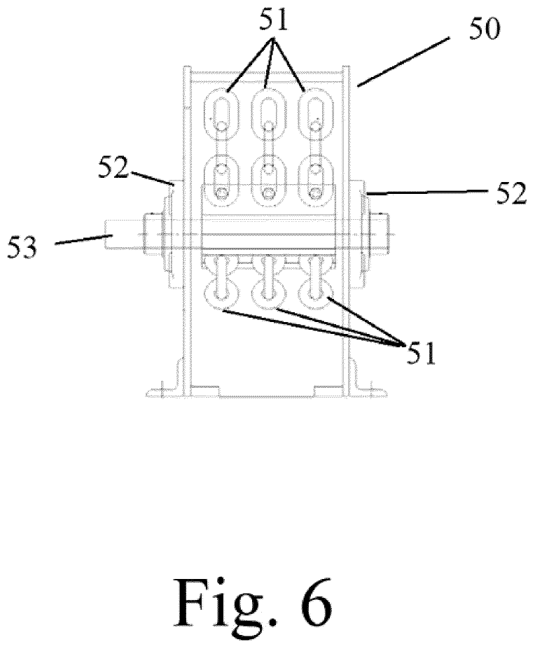

As shown in FIGS. 5 and 6, in the preferred embodiment, the Single stage destructive apparatus 50 is a chain impact mill. A chain impact mill is a simple yet effective mechanism. Its performance does not depend on data a bearing device surface flatness or applied pressure. Instead, the chain mill 51 relies solely on the physics of impact, like a hammer. For the data bearing device materials, this principle delivers excellent efficiency, producing a consistent discharge particle size by leveraging favorable physical dynamics.

Fiberglass circuit boards are mechanically brittle and are prone to cracking under stress. Integrated circuits that contain the data are even more brittle and fragile devices and within a few seconds are particle-lized.

In the preferred embodiment, the chain impact mill 50 has a housing in which welded-link hardened alloy chains 51 are connected to an axis 53. The axis 53 is held by a pair of brackets 52 with openings for the axis 51 allowing the axis 53 to be turned by the motor 55. The welded-link chains 51 can last longer than simple twisted-link or farm chains. The chains 51 are turned by the axis 53 and perform a hammering function where the chains 51 hit the solid-state data bearing devices 10 reducing them to particles 300.

The axis 53 is driven by the motor 55 at a moderate RPM operating Speed and duty Cycle which keeps the machine viable.

As shown in FIGS. 5 and 6 the chains 51 have proper clearances and chain slop to prevent the chains 51 hitting too closely against walls to prevent wear and increase functionality. The proper spacing extends the life of the device 1.

The device, in the preferred embodiment, is a high-speed hammer impacting the circuit boards.

Other systems do not reduce all data bearing components 15 of a solid-state data bearing device 10 to a particle size of 2 mm or smaller. Other systems perform incomplete destruction since they do not destroy the data on all of the data bearing components 15 of a solid-state data bearing device. Other systems destroy data bearing devices 10 in a location that is outside the secure confines of a data center or enterprise facility, which constitutes a security risk. Other systems may reduce air quality in the areas where they are being used. In existing designs, these current designs require blade sharpening and motor replacements since they are essentially shredders. These other systems overheat and have to be replaced becoming e-waste themselves.

Since there are so few mechanical components in the design, a Device 1 can last 100 times longer than a shredding machine with a fraction of the complexity to build. This Device1 is portable and is intended to be used within the customer's secure confines of a data center or enterprise facility. This Device 1 includes a particle collection system 200 and a filtration system 80 to preserve air quality where it is located.

Also, it can produce a new method to destroy data on data bearing components 15 of solid-state devices 10.

### Process

Step 1 begins the process of data destruction after the organization has determined a solid-state data bearing device 10 has reached its end of life and has been processed and designated for destruction. The trained technician inserts the circuit board 15 removed from the solid-state data bearing device 10 into the drop-in chute 40 and closes the safety guard 45. Step 2 is the process that uses the single stage destructive apparatus/50 to reduce the data bearing components 15 from the solid-state data bearing device 10 to particle size of 2 mm or smaller to meet cybersecurity regulations for destruction. Step 3 is the process of filtering the particles 300 through a specified size of screen 100 to ensure that particles moving through the size filtering screen system meet the cybersecurity regulations. Step 4 completes the process by containing the particles of the data bearing components 15 after the data has been reduced to the size needed to meet cybersecurity regulations. Step 5 is a system to filter the air in the area where the particle-lizer is being used to meet OSHA Permissible Exposure Limits.

### Advantages

By following the particle-lizer mechanism's process, the organization can be confident that the data bearing components 15 of the solid-state data bearing device 10 have been reduced to a particle size of 2 mm or smaller rendering the data unusable. This alleviates the potential problem of the organization damaging their brand due to leaks of secure data onto the global network. It solves the insider threat in cybersecurity. It saves the organization time and effort in marketing and answering claims in the legal system regarding secure data breaches. It helps the organization meet cybersecurity regulations and avoid significant fines for non-compliance. It is a simpler machine to process Internet of Things devices 10 that is a durable, single stage mechanism that is not shredders, which require maintenance and have a high failure rate, and therefore become e-waste themselves.

Any organization that wants to securely remove not only digital information, but also immediately destroy mechanical information such as a shape and size of a design by reducing the components to 2 mm or smaller particle size can use this particle-lizer mechanism.

The tool life of the Device 1 is years since it is not shredding or using cutting blades. It uses a hammering process like a rock crusher while other designs use cutting blades which require daily maintenance. The hammer principle destroys solid state devices more efficiently than shredding, cutting, or grinding and does not require tool changes. It runs on standard 120-volt single phase power receptacle while the other designs use high power of multiphase power. Multi-phase outlets are not standard in every facility. It is small and portable 14 in.×22 in.×33 in. and weighs approximately 75 lbs. in the preferred embodiment. It has a precision input drawer that provides dust tight operations.

### CONCLUSION

The current invention is a new method to destroy data on data bearing components of solid-state devices using hammering principle rather than cutting, shredding, or grinding techniques. A new method to destroy data on the solid-state circuit boards without replaces the tool, performing tool maintenance or calibration.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to.

1. A device for destroying data:
a portable mechanism with an outer case, drop-in chute where the drop-in chute has a safety guard, a single stage destructive apparatus, a size filtering screen system and a particle collection system where the data is on data bearing components from solid-state data bearing devices where the device can be configured to produce particles of different particle 2 mm or smaller based on the screening of the particles and having an air filtration system to preserve air quality where the portable mechanism can be produced in a variety of sizes.

2. The device according to claim 1 comprising:
where the single stage destructive apparatus is a hammer apparatus.

3. The device according to claim 1 comprising:
where the single stage destructive apparatus is a chain impact mill.

4. The device according to claim 3 comprising:
having welded-link hardened alloy chains.

5. The device according to claim 3 comprising:
where the chains are attached to an axis.

6. The device according to claim 4 comprising:
where the axis is connected to a motor.

7. The device according to claim 4 comprising:
where the axis is held by a plurality of brackets.

8. The device according to claim 7 comprising:
where the axis turns in the brackets.

9. The device according to claim 5 comprising:
where the axis turns the chains which hammer the solid-state data bearing devices.

10. The device according to claim 1 comprising:
where the particles flow through a particle tube from the single stage destructive apparatus to the particle collection system.

11. The device according to claim 1 comprising:
where the air filtration system is connected to the collection system by an air filtration tube.

12. The device according to claim 1 comprising:
having a filtering screen system.

13. A process to destroy data using the device of claim 1.

14. A device for destroying data:
a portable mechanism with an outer case, drop-in chute where the drop-in chute has a safety guard, a single stage is a chain impact mill, a size filtering screen system and a particle collection system where the data is on data bearing components from solid-state data bearing devices where the device can be configured to produce particles of different particle 2 mm or smaller based on the screening of the particles and having an air filtration system to preserve air quality where the portable mechanism can be produced in a variety of sizes and where the particles flow through a particle tube from the single stage destructive apparatus to the particle collection system.

15. The device according to claim 14 comprising:
having welded-link hardened alloy chains.

16. The device according to claim 14 comprising:
where the chains are attached to an axis.

17. The device according to claim 16 comprising:
where the axis is connected to a motor.

18. The device according to claim 16 comprising:
where the axis is held by a plurality of brackets.

19. The device according to claim 18 comprising:
where the axis turns in the brackets.

20. The device according to claim 17 comprising:
where the axis turns the chains which hammer the solid-state data bearing devices.
